(19) United States
(12) Patent Application Publication
(10) Pub. No.: US 2022/0253070 A1
(43) Pub. Date: Aug. 11, 2022

(54) AUTONOMOUS MOBILE DEVICE AND METHOD FOR OPERATING AN AUTONOMOUS MOBILE DEVICE

(71) Applicant: Robert Bosch GmbH, Stuttgart (DE)

(72) Inventors: Gor Hakobyan, Stuttgart (DE); Johannes Fink, Karlsruhe (DE)

(21) Appl. No.: 17/587,683

(22) Filed: Jan. 28, 2022

(30) Foreign Application Priority Data
Feb. 5, 2021 (DE) 10 2021 201 068.7

(51) Int. Cl. G05D 1/02

(52) U.S. Cl. CPC G05D 1/0257; G05D 2201/0215; G05D 1/0214

(57) ABSTRACT

An autonomous mobile device, in particular an autonomous work device. The device includes at least one device frame; at least one drive unit for generating a propulsion force; at least one detection unit, situated in or at the device frame, for detecting the surroundings of the device frame, the detection unit including at least one synthetic aperture radar sensor; and at least one control or regulation unit for controlling or regulating the drive unit and/or the detection unit. The control or regulation unit is configured to activate the drive unit in such a way that a self-rotation of the device frame about a vertical axis of the device frame to form a circular synthetic aperture takes place with the aid of the synthetic aperture radar sensor.

### BACKGROUND INFORMATION

An autonomous mobile device including at least one device frame, at least one drive unit for generating a propulsion force, and at least one detection unit, situated at the device frame, for detecting the surroundings of the device frame is described in European Patent Application No. EP 3 599 484 A1, the detection unit including at least one synthetic aperture radar (SAR) sensor, and at least one control or regulation unit for controlling or regulating the drive unit and/or the detection unit.

### SUMMARY

The present invention is directed to an autonomous mobile device, in particular an autonomous work device, including at least one device frame, at least one drive unit for generating a propulsion force, at least one detection unit, situated at the device frame, for detecting the surroundings of the device frame, the detection unit including at least one synthetic aperture radar (SAR) sensor, and at least one control or regulation unit for controlling or regulating the drive unit and/or the detection unit.

In accordance with an example embodiment of the present invention, it is provided that the control or regulation unit is configured to activate the drive unit in such a way that a self-rotation of the device frame about a vertical axis of the device frame to form a circular synthetic aperture takes place with the aid of the synthetic aperture radar sensor. The control or regulation unit is preferably configured to at least partially create a surroundings map and/or to ascertain a location of the device frame as a function of data that are detected with the aid of the circular synthetic aperture. Objects are preferably detectable in a detection range of the circular synthetic aperture with the aid of the circular synthetic aperture. In particular, the control or regulation unit is configured to create a surroundings map and/or ascertain a location, based on the data detected with the aid of the circular synthetic aperture, prior to a propulsion, in particular a translatory movement, of the autonomous mobile device. The vertical axis extends in particular through a midpoint of the device frame, preferably at least viewed in a main plane of extension of the device frame. A “main plane of extension” of a constructional unit or an element is understood in particular to mean a plane that extends in parallel to a largest lateral face of a smallest possible imaginary cube that just completely encloses the constructional unit, and in particular extends through the midpoint of the cube. The vertical axis preferably extends at least essentially perpendicularly with respect to the main plane of extension of the device frame. The expression “essentially perpendicularly” is intended here to define in particular an orientation of a direction relative to a reference direction, the direction and the reference direction, in particular viewed in a projection plane, encompassing an angle of 90°, and the angle having a maximum deviation of in particular less than 8°, advantageously less than 5°, and particularly advantageously less than 2°. Alternatively, it is also possible for the vertical axis to extend offset relative to a midpoint of the device frame, in particular at least viewed in the main plane of extension of the device frame. The vertical axis of the device frame preferably intersects the device frame. Alternatively, it is also possible for the vertical axis to be free of an intersection point with the device frame.

The autonomous mobile device is preferably designed as an autonomous work device, preferably as an autonomous lawn mower robot or as an autonomous vacuum robot. However, it is also possible for the autonomous mobile device to be designed as a drone, as an autonomous transport vehicle, in particular as an automated guided vehicle (AGV), as a drivable autonomous industrial robot, as an autonomous service robot, or the like. In particular, the autonomous mobile device is configured to move independently. Preferably, the autonomous mobile device is designed differently from an autonomous device that is permanently installed at a position, in particular an industrial robot. The vertical axis preferably extends at least essentially perpendicularly with respect to a base contact surface of a chassis of the autonomous mobile device, in particular for an autonomous mobile device designed as a floor vehicle. The vertical axis preferably extends at least essentially perpendicularly with respect to a base surface on which the autonomous mobile device moves, in particular for an autonomous mobile device designed as a floor vehicle. In particular, the main plane of extension of the device frame extends at least essentially in parallel to the base contact surface, in particular for an autonomous mobile device designed as a floor vehicle. “Essentially parallel” is understood here in particular to mean an orientation of a direction relative to a reference direction, in particular in a plane, the direction with respect to the reference direction having a deviation in particular less than 8°, advantageously less than 5°, and particularly advantageously less than 2°. For an autonomous mobile device designed as a drone, the vertical axis preferably extends at least essentially perpendicularly with respect to a standing plane of the autonomous mobile device. The main plane of extension preferably extends at least essentially in parallel to the standing plane of the autonomous mobile device designed as a drone. The drive unit includes at least one electric motor or the like. The device frame is understood in particular to mean the undercarriage, the frame, the chassis, or the base frame of the autonomous mobile device. At least in one embodiment of the autonomous mobile device designed as a floor vehicle, the chassis of the autonomous mobile device is situated at the device frame. It is possible for the chassis to be at least partially formed by the device frame. The autonomous mobile device, in particular the chassis, preferably includes at least one chain unit, one roller unit, and/or one wheel unit for propulsion of the autonomous mobile device on a base surface.

The base contact surface is preferably formed by a support surface of the wheel unit, of the chain unit, and/or of the roller unit. The chain unit includes in particular at least one crawler track, preferably at least two crawler tracks. For a design of the autonomous mobile device, in particular the chassis, with two crawler tracks, the two crawler tracks are preferably situated symmetrically around the midpoint of the device frame, at least viewed in the main plane of extension of the device frame. In addition, it is possible for the chain unit to include more than two crawler tracks, which are preferably situated symmetrically with respect to the midpoint of the device frame or which have some other arbitrary arrangement relative to the midpoint of the device frame, in particular at least viewed in the main plane of extension of the device frame. The chain unit is drivable in particular with the aid of the drive unit. The wheel unit includes, for example, at least one wheel, preferably at least two wheels, preferably at least three wheels, and particularly preferably at least four wheels. It is possible for the wheel unit to include at least one front wheel and two rear wheels. In particular, at least one wheel of the wheel unit is drivable by the drive unit. It is possible for at least one wheel of the wheel unit to be steerably situated. It is also possible for at least one wheel of the wheel unit to be situated at a fixed axle. Furthermore, it is possible for all wheels of the wheel unit to be drivable, in particular individually, preferably independently of one another, with the aid of the drive unit. The wheels of the wheel unit are preferably designed as wheels that appear meaningful to those skilled in the art, for example as rubber wheels or the like. It is also possible for at least one wheel of the wheel unit to be designed as a Mecanum wheel. The roller unit includes, for example, at least one roller, preferably at least two rollers, preferably at least three rollers, and particularly preferably at least four rollers. In particular, at least one roller of the roller unit is drivable by the drive force. It is also possible for all rollers of the roller unit to be drivable, in particular individually, preferably independently of one another, with the aid of the drive unit. For example, the roller unit includes at least two drive rollers and at least one guide roller. At least in one preferred exemplary embodiment, the autonomous mobile device, in particular the chassis, includes at least two rear wheels that are drivable, preferably individually, preferably independently of one another, and at least one guide roller. However, other configurations of the chassis, in particular of the roller unit, the wheel unit, and/or the chain unit, that appear meaningful to those skilled in the art are also possible. In particular, in at least one exemplary embodiment of the autonomous mobile device designed as a drone, the autonomous mobile device includes at least one propeller unit, one turbine unit, or the like for propulsion. The propeller unit is preferably drivable with the aid of the drive unit. The propeller unit includes, for example, at least one propeller, preferably at least two propellers and particularly preferably at least four propellers. The turbine unit includes, for example, at least one, preferably multiple, turbines.

In accordance with an example embodiment of the present invention, the drive unit is preferably configured to drive the chassis, in particular the wheel unit, the roller unit, the chain unit, the propeller unit, or the like. A movement of the device frame is in particular coupled to a drive, in particular a movement, of the chassis. A movement of the device frame is generatable by the chassis, which is preferably driven with the aid of the drive unit. In particular, the movement of the device frame is a function of an activation by the control or regulation unit. The drive unit is preferably provided for driving the chassis for a translatory and/or rotatory movement of the device frame, in particular as a function of an activation by the control or regulation unit. The control or regulation unit is preferably configured to activate the drive unit at least for a propulsion, in particular a translatory movement, as a function of a surroundings map that is created and/or a location of the autonomous mobile device, in particular of the device frame, that is ascertained, based on data that are measured with the aid of the circular synthetic aperture. A movement of the synthetic aperture radar is preferably generatable by a self-rotation of the device frame in order to preferably form a circular synthetic aperture with the aid of the synthetic aperture radar. A movement of the synthetic aperture radar sensor is particularly preferably coupled to a movement of the device frame. A movement of the synthetic aperture radar sensor is preferably synchronous with a movement of the device frame. In particular, a transmission ratio of a movement of the device frame into a movement of the synthetic aperture radar sensor is 1:1. The control or regulation unit is preferably configured to activate the drive unit in such a way that a self-rotation of the device frame about the vertical axis to form a circular synthetic aperture takes place with the aid of the synthetic aperture radar sensor, the circular synthetic aperture detecting the surroundings of the device frame in an angular range of 360°, preferably at least viewed in the main plane of extension of the device frame. The control or regulation unit is preferably configured to generate a self-rotation of the device frame about the vertical axis about a rotational angle of 360° in order to form a circular synthetic aperture with the aid of the synthetic aperture radar sensor, the circular synthetic aperture detecting the surroundings of the device frame in an angular range of 360°, in particular at least viewed in the main plane of extension of the device frame. It is also possible for the control or regulation unit to be configured to activate the drive unit in such a way that a self-rotation of the device frame about the vertical axis to form a circular synthetic aperture takes place with the aid of the synthetic aperture radar sensor, the circular synthetic aperture detecting the surroundings of the device frame in an angular range of less than 360°, in particular less than 180°. In particular, an angular range that is detectable by the circular synthetic aperture is a function of a rotational angle about which the device frame rotates about the vertical axis. An angular range that is detectable with the aid of the circular synthetic aperture, which is formable in particular with the aid of the synthetic aperture radar sensor by a self-rotation of the device frame about the vertical axis, preferably corresponds to a rotational angle of the self-rotation of the device frame about the vertical axis. An angular range that is to be detected by the circular synthetic aperture is preferably adjustable. A collision-free propulsion of an autonomous mobile device may advantageously be assisted. A detection unit for localization of the autonomous mobile device and for mapping of the surroundings of the autonomous mobile device may be advantageously implemented with a simple design. The number of moving parts may advantageously be kept low, so that a particularly low-wear detection unit may be provided in a particularly advantageous manner. A particularly space-saving detection unit for localization and/or mapping may advantageously be provided. Components that are already present, at least in part, in particular the chassis, the control or regulation unit, and/or the drive unit, of the autonomous mobile device may advantageously be used to generate a movement of the synthetic aperture radar sensor to form a circular synthetic aperture.

In addition, in accordance with an example embodiment of the present invention, it is provided that the control or regulation unit is configured to evaluate the data, measured with the aid of the circular synthetic aperture, based on a simultaneous localization and mapping (SLAM) method. The simultaneous localization and mapping (SLAM) method is in particular a method for simultaneous position determination and map creation in robotics, in particular in the method, a virtual map of the surroundings and a spatial position of a movable unit, in particular the autonomous mobile unit, within the virtual map being ascertained, preferably at the same time. In the simultaneous localization and mapping (SLAM) method, a plurality of virtual points is preferably detected from the surroundings of the detection unit. With the aid of the detection unit, the virtual points are preferably detectable via features that are depicted on a detected image plane, the individual features being ascertained via a phase position evaluation, an intensity evaluation, a polarization evaluation, or the like by radar echoes that are received by the synthetic aperture radar sensor.

The features preferably include multiple virtual points that in particular form a cluster and that are preferably in a certain geometric relationship with one another. The virtual points are preferably ascertainable in each case as a function of positions of a depiction of a feature in each case ascertained from at least two detected images, with the aid of the control or regulation unit. In particular, a feature is associated with each virtual point. A surroundings map is preferably creatable and at the same time, a location of the autonomous mobile device, in particular the device frame, is ascertainable, in particular based on the SLAM method, with the aid of the control or regulation unit based on the virtual points. The control or regulation unit is preferably configured to evaluate the data, measured with the aid of the circular synthetic aperture, based on the SLAM method, free of a translatory movement of the device frame for a simultaneous mapping and localization of the autonomous mobile device, in particular the device frame. The control or regulation unit is preferably configured to activate the drive unit to drive the chassis in such a way that a self-rotation of the housing (device) frame, and thus in particular a movement of the synthetic aperture radar sensor to form a circular synthetic aperture, take place due to the driven chassis, so that the data required for the SLAM method are detectable by the circular synthetic aperture. A surroundings mapping and a localization of the autonomous mobile device may advantageously be enabled prior to a propulsion of the autonomous mobile device. A collision-free operation, in particular a collision-free initial propulsion, of the autonomous mobile device may advantageously be ensured. A particularly efficient operation of the autonomous mobile device may be advantageously achieved. Damage to objects in a propulsion area of the autonomous mobile device due to collisions with the autonomous mobile device may be advantageously counteracted.

Moreover, it is provided that the control or regulation unit is configured to activate the drive unit to propel the device frame at least as a function of data that are measured with the aid of the circular synthetic aperture, in particular for a collision-free operation. In particular, the control or regulation unit is configured to activate the drive unit to propel the device frame at least as a function of a map of the surroundings of the device frame and/or as a function of a location of the device frame, which in particular are/is ascertainable based on data that are measured with the aid of the circular synthetic aperture, preferably for a collision-free operation. The control or regulation unit is preferably configured to ascertain, in particular during an initial start-up in an initial step, an initial map of the surroundings of the device frame, and/or an initial location of the device frame, based on data that are measured with the aid of the circular synthetic aperture, in particular for a collision-free operation. In particular, the control or regulation unit is configured to ascertain a map of the surroundings of the device frame and/or a location of the device frame, free of and/or prior to a translatory movement of the device frame, preferably in an initial step during an initial start-up, preferably as a function of data that are detected with the aid of the circular synthetic aperture. The control or regulation unit is preferably configured to activate the drive unit to propel the device frame at least as a function of a dimension of the device frame, in particular as a function of a maximum spatial extent of the device frame, in particular for a collision-free operation. It is possible for the control or regulation unit to be configured to activate the drive unit to propel the device frame at least as a function of components/accessories situated at the device frame, in particular as a function of a spatial extent of components/accessories situated at the device frame, in particular for a collision-free operation. A propulsion of the device frame at a distance from objects that are detected in the surroundings of the device frame is preferably generatable at least as a function of a dimension, in particular a maximum spatial extent, of the housing (device) frame and/or of components/accessories situated at the housing (device) frame, in particular as a function of their maximum spatial extent. It is possible for a dimension, in particular a spatial extent, of the device frame and/or of components/accessories situated at the device frame to be detectable and/or ascertainable with the aid of the detection unit and/or the control or regulation unit.

The accessories may include, for example, a bucket, a collection container, or the like. The control or regulation unit is preferably configured to activate the drive unit to drive the chassis in order to generate at least one translatory initial movement of the device frame as a function of the initial map of the surroundings of the device frame, of the initial location of the device frame, of a spatial extent of the device frame, and/or as a function of components/accessories situated at the device frame, in particular as a function of their spatial extent. It is possible for a translatory movement of the device frame to be blockable as a function of the presence of an initial map of the surroundings of the device frame and/or of a location of the device frame. A collision-free operation, in particular a collision-free initial propulsion, of the autonomous mobile device may be advantageously ensured. Damage to objects in a propulsion area of the autonomous mobile device due to collisions with the autonomous mobile device may be advantageously counteracted.

In addition, it is provided that the synthetic aperture radar sensor for generating a circular synthetic aperture is rotatably fixedly, in particular rigidly, connected to the device frame. It is possible for the synthetic aperture radar sensor to be situated directly at the device frame, in particular fastened thereto. It is also possible for the synthetic aperture radar sensor to be situated in or at a housing of the autonomous mobile device, at least a portion of the housing to which the synthetic aperture radar sensor is fastened being rigidly, in particular rotatably fixedly, connected to the device frame. The synthetic aperture radar sensor is preferably rotatably fixedly situated at the device frame and/or at the housing, free of a possibility of relative movement, in particular free of a movable bearing by a bearing unit designed as a roller bearing, as a slide bearing, or the like, relative to the device frame and/or the housing. The control or regulation unit and/or the drive unit are/is preferably situated at least partially, preferably at least essentially completely, within the housing. “At least essentially completely” is understood in particular to mean at least 50%, preferably at least 75%, and particularly preferably at least 90%, of a total volume and/or a total mass of an object, in particular of a unit. In particular, the device frame is provided to support the housing, and/or at least partially forms the housing. “Provided” is understood in particular to mean specially programmed, designed, and/or equipped. The statement that “an object is provided for a certain function” is understood in particular to mean that the object fulfills and/or carries out this certain function in at least one use state and/or operating state. The synthetic aperture radar sensor is preferably situated at the housing at an outer surface of the housing, the housing preferably being rigidly, in particular rotatably fixedly, connected to the device frame. However, it is alternatively also possible for the housing to be situated at the device frame so that it is at least partially movably supported relative to the device frame, the synthetic aperture radar sensor being rigidly, in particular rotatably fixedly, connected to the device frame, for example situated directly at the device frame, in particular fastened thereto. It is also possible for the synthetic aperture radar sensor to be designed, at least in part, as one piece with the device frame and/or the housing. The statement that “at least one object and at least one further object are designed, at least in part, as one piece with one another” is understood in particular to mean that at least one component of the object is designed as one piece with at least one further component of the further object. A circular synthetic aperture having a simple design may advantageously be formed. A circular synthetic aperture may advantageously be provided at an autonomous mobile device without additional moving components. A particularly robust detection unit may be advantageously implemented. A circular synthetic aperture may be advantageously formed in a particularly cost-effective manner.

Furthermore, it is provided that the synthetic aperture radar sensor, viewed in a plane extending perpendicularly with respect to the vertical axis of the device frame, is situated offset relative to the vertical axis. The plane extending perpendicularly with respect to the vertical axis of the device frame preferably extends at least essentially in parallel to the main plane of extension of the device frame. The plane extending perpendicularly with respect to the vertical axis of the device frame preferably corresponds to the main plane of extension of the device frame. A movement of the synthetic aperture radar sensor on a circular path, in particular about the vertical axis, is preferably generatable by a self-rotation of the device frame about the vertical axis. The circular path preferably extends at least essentially in parallel to the main plane of extension of the device frame. The synthetic aperture radar sensor preferably includes at least one main point of action that corresponds in particular to a main point of emission and/or a main point of reception of the synthetic aperture radar sensor. A maximum transmission power and/or a maximum reception power of the synthetic aperture radar sensor are/is preferably achievable at the main point of action. The main point of emission is in particular a point of the antenna directional characteristic of the synthetic aperture radar sensor at which a maximum transmission power of the synthetic aperture radar sensor is achievable. The main point of reception is in particular a point of the antenna directional characteristic of the synthetic aperture radar sensor at which a maximum reception power of the synthetic aperture radar sensor is achievable. The synthetic aperture radar sensor preferably has at least one center axis that preferably extends at least essentially in parallel to the vertical axis. The center axis of the synthetic aperture radar sensor intersects in particular at least the main point of action of the synthetic aperture radar sensor. The center axis of the synthetic aperture radar sensor particularly preferably extends at a distance from the vertical axis. The main point of action of the synthetic aperture radar sensor is preferably spaced apart from the vertical axis of the device frame. A movement of the synthetic aperture radar sensor is preferably a function of a movement of the device frame. The synthetic aperture radar sensor has in particular a main effective axis along which a maximum transmission power and/or maximum reception power of the synthetic aperture radar sensor are/is achievable. The main effective axis of the synthetic aperture radar sensor preferably extends at least essentially perpendicularly with respect to the vertical axis of the housing (device) frame and/or with respect to the center axis of the synthetic aperture radar sensor. The main effective axis and the center axis preferably intersect at a point that preferably corresponds to the main point of action of the synthetic aperture radar sensor. A main direction of irradiation along which the synthetic aperture radar sensor has a maximum radiation power preferably extends in parallel to the main effective axis of the synthetic aperture radar sensor. The main direction of irradiation of the synthetic aperture radar sensor particularly preferably extends radially outwardly, at least viewed starting from the vertical axis of the housing (device) frame. A main direction of reception along which the synthetic aperture radar sensor has a maximum reception power extends in particular in parallel to the main effective axis of the synthetic aperture radar sensor, preferably in a direction opposite the main direction of irradiation. A particularly space-saving detection unit and/or a particularly high-resolution detection unit may be advantageously provided. A particularly large circular synthetic aperture having a simple design may be advantageously generated with the aid of a synthetic aperture radar sensor, in particular without additional necessary moving components. A particularly high-resolution map of the surroundings of the autonomous mobile device may advantageously be created. A particularly accurate localization of the autonomous mobile device may be advantageously achieved. A collision-free propulsion of the autonomous mobile device may be advantageously assisted in a particularly cost-effective manner.

Furthermore, it is provided that the detection unit, in particular in at least one exemplary embodiment of the autonomous mobile device, includes at least two synthetic aperture radar sensors which, viewed in a plane, in particular the above-mentioned plane, extending perpendicularly with respect to the vertical axis of the device frame are situated offset relative to the vertical axis. The at least two synthetic aperture radar sensors are preferably situated symmetrically about the vertical axis. Alternatively, it is also possible for the at least two synthetic aperture radar sensors to be situated asymmetrically about the vertical axis of the device frame. The at least two synthetic aperture radar sensors are preferably rigidly, in particular rotatably fixedly, connected to the device frame. It is possible for the at least two synthetic aperture radar sensors to be situated directly at the device frame, in particular fastened thereto. It is also possible for the at least two synthetic aperture radar sensors to be situated at a portion of the housing that is rigidly, in particular rotatably fixedly, connected to the device frame. The at least two synthetic aperture radar sensors each preferably include a main point of action that in particular corresponds to a main point of emission and/or a main point of reception of the particular synthetic aperture radar sensor. The at least two synthetic aperture radar sensors preferably each have a center axis that preferably extends at least essentially in parallel to the vertical axis. The particular center axis of the at least two synthetic aperture radar sensors intersects in particular at least the main point of action of the particular synthetic aperture radar sensor. The center axes of the at least two synthetic aperture radar sensors extend at least essentially in parallel to one another. The center axes of the at least two synthetic aperture radar sensors particularly preferably extend at least essentially in parallel to the vertical axis, and are preferably situated at a distance from the vertical axis. The at least two synthetic aperture radar sensors preferably each have a main effective axis, the main effective axes extending at least essentially in parallel to one another or at an angle to one another. In particular, a maximum transmission power and/or maximum reception power of the particular synthetic aperture radar sensor are/is achievable along the particular main effective axis of the at least two synthetic aperture radar sensors. The particular main effective axes of the at least two synthetic aperture radar sensors preferably extend in the main plane of extension of the device frame or extend at least in parallel to the main plane of extension of the device frame. The particular main effective axes of the at least two synthetic aperture radar sensors particularly preferably intersect at at least one point. The particular main effective axes of the at least two synthetic aperture radar sensors preferably intersect with the vertical axis at least at a shared intersection point. It is also possible for the at least two of the main effective axes of the at least two synthetic aperture radar sensors to correspond to one another. Particular main directions of irradiation of the at least two synthetic aperture radar sensors preferably extend in opposite directions or extend at an angle to one another. A particularly high-resolution detection unit may be advantageously provided. A particularly large angular range around the autonomous mobile device may be advantageously mapped. A particularly reliable and accurate localization of the autonomous mobile device may be advantageously achieved. Particularly rapid surroundings mapping may advantageously take place. Different areas around the autonomous mobile device may advantageously be detected and/or monitored at the same time.

In addition, it is provided that the detection unit includes at least two synthetic aperture radar sensors which together form a circular synthetic aperture via a self-rotation of the device frame, generated with the aid of the drive unit, about the vertical axis of the device frame. In particular, the control or regulation unit is configured to activate the drive unit in such a way that a self-rotation of the device frame about the vertical axis takes place, so that a circular synthetic aperture is formable by each of the at least two synthetic aperture radar sensors. The control or regulation unit is preferably configured to process data, detected with the aid of the particular circular synthetic aperture, of the at least two synthetic aperture radar sensors, to ascertain a surroundings map and/or to locate the device frame, preferably based on a SLAM method. It is also possible for the control or regulation unit to be configured to create in each case a surroundings map as a function of data of the at least two synthetic aperture radar sensors that are measured with the aid of the particular synthetic aperture, and/or to ascertain a location of the device frame, preferably based on a SLAM method. The control or regulation unit is particularly preferably configured to compare the surroundings maps, created with the aid of the particular circular synthetic aperture of the at least two synthetic aperture radar sensors, and/or to combine them to form a combined surroundings map. The control or regulation unit is particularly preferably configured to compare the locations of the device frame, ascertained with the aid of the control or regulation unit, in particular as a function of the data that are detected with the aid of the particular circular synthetic aperture of the at least two synthetic aperture radar sensors. In particular, it is possible for an average value for a location of the device frame to be ascertainable by the control or regulation unit, based on locations of the device frame that are ascertained in particular as a function of the data that are detected with the aid of the particular circular synthetic aperture of the at least two synthetic aperture radar sensors.

Particularly accurate and rapid surroundings mapping and/or localization of the autonomous mobile device, in particular of the device frame, may advantageously take place. A location and/or a surroundings map may advantageously be at least partially checked for correctness. A surroundings mapping in an angular range may advantageously take place, it being possible for a rotational angle of the device frame to be smaller than the angular range.

Moreover, the present invention is directed to a method for operating an autonomous mobile device, in particular the above-mentioned autonomous mobile device, the autonomous mobile device including a detection unit, in particular the above-mentioned detection unit, for detecting the surroundings of the autonomous mobile device, and the detection unit including at least one synthetic aperture radar (SAR) sensor, in particular the above-mentioned synthetic aperture radar (SAR) sensor. It is provided that in one method step a drive unit, in particular the above-mentioned drive unit, of the autonomous mobile device is activated by a control or regulation unit, in particular the above-mentioned control or regulation unit, for generating a self-rotation of a device frame, in particular the above-mentioned device frame, of the autonomous mobile device about a vertical axis, in particular the above-mentioned vertical axis, so that a circular synthetic aperture, in particular the above-mentioned circular synthetic aperture, for a localization of the autonomous mobile device and/or for a mapping of the surroundings of the autonomous mobile device is formed by the synthetic aperture radar sensor. The synthetic aperture radar sensor is preferably moved synchronously with the device frame in the method step. The device frame is rotated relative to the base surface and/or the surroundings in the method step, with the aid of the drive unit. The synthetic aperture radar sensor is particularly preferably moved on a circular path, in particular about the vertical axis, by a self-rotation of the device frame about the vertical axis. The method step is preferably carried out prior to a translatory movement of the autonomous mobile device, in particular of the device frame. The method step represents in particular an initial step during an initial start-up of the autonomous mobile device. For example, in the method step the device frame is rotated about a rotational angle of 360° about the vertical axis with the aid of the drive unit. However, it is also possible for the device frame to be rotated in the method step about a rotational angle of less than 360°, preferably less than 180°, or greater than 360°, in particular as a function of an angular range around the autonomous mobile device, in particular the device frame, to be monitored. The control or regulation unit is preferably configured to process the data, detected in the method step with the aid of the circular synthetic aperture, for creating a surroundings map and/or for ascertaining a location of the autonomous mobile device, in particular of the device frame.

Objects in a detection range of the circular synthetic aperture are preferably detected in the method step with the aid of the circular synthetic aperture. A circular synthetic aperture may advantageously be generated, using a synthetic aperture radar sensor, with a simple design and in a cost-effective manner. Additional moving components for forming a circular synthetic aperture may advantageously be dispensed with. A particularly low-wear design for forming a circular synthetic aperture may be advantageously implemented. A low-collision propulsion of the autonomous mobile device may be advantageously assisted. Data for a localization and/or mapping may be advantageously detected in a particularly space-saving manner.

Furthermore, in accordance with an example embodiment of the present invention, it is provided that the data measured with the aid of the circular synthetic aperture are evaluated in a further method step, based on a SLAM method. In particular, a virtual map of the surroundings of the autonomous mobile device and a spatial position of the autonomous mobile device within the virtual map are ascertained, in particular at the same time, in the further method step. In particular, a plurality of virtual points from the surroundings of the detection unit is detected in the method step. The virtual points are preferably detected in the method step with the aid of the detection unit, in particular the circular synthetic aperture, via features that are depicted on a detected image plane. The individual features are preferably ascertained in the further method step via a phase position evaluation, an intensity evaluation, a polarization evaluation, or the like by radar echoes that are received by the synthetic aperture radar sensor. The virtual points are preferably ascertained in the further method step, with the aid of the control or regulation unit, in each case as a function of positions, ascertained from at least two detected images, of a depiction of a feature in each case. A surroundings map is preferably created based on the virtual points in the further method step, with the aid of the control or regulation unit, and at the same time a location of the autonomous mobile device, in particular of the device frame, is ascertained, in particular based on the SLAM method. A collision-free operation of the autonomous mobile device may be advantageously achieved. A mapping and localization may be advantageously enabled, with a simple design, with the aid of a self-rotation of the autonomous mobile device.

In addition, in accordance with an example embodiment of the present invention, it is provided that in one method step, with the aid of multiple synthetic aperture radar sensors, in particular the above-mentioned at least two synthetic aperture radar sensors, situated at the device frame, a combined circular synthetic aperture is generated by a self-rotation of the device frame about the vertical axis of the device frame that is generated with the aid of the drive unit. In the method step, the drive unit is preferably activated with the aid of the control or regulation unit in such a way that a self-rotation of the device frame about the vertical axis takes place, so that a circular synthetic aperture is formed by each of the at least two synthetic aperture radar sensors. In a further method step, in particular the above-mentioned further method step, data that are detected with the aid of the particular circular synthetic apertures of the at least two synthetic aperture radar sensors are preferably processed with the aid of the control or regulation unit to create a surroundings map and/or to locate the device frame, preferably based on a SLAM method. It is also possible that in the further method step, a surroundings map is created and/or a location of the device frame is ascertained, in each case with the aid of the control or regulation unit, as a function of data that are measured with the aid of the particular synthetic aperture of the at least two synthetic aperture radar sensors, preferably based on a SLAM method. In the further method step, surroundings maps that are created with the aid of the particular circular synthetic aperture of the at least two synthetic aperture radar sensors are particularly preferably compared and/or combined to form a combined surroundings map with the aid of the control or regulation unit. In the further method step, the locations of the device frame that are ascertained with the aid of the control or regulation unit, in particular as a function of the data that are detected with the aid of the particular circular synthetic apertures of the at least two synthetic aperture radar sensors, are particularly preferably compared with the aid of the control or regulation unit. In particular, it is possible for an average value for a location of the device frame to be ascertained in the further method step, with the aid of the control or regulation unit, from the locations of the device frame ascertained in particular as a function of the data that are detected with the aid of the particular circular synthetic apertures of the at least two synthetic aperture radar sensors. Particularly accurate and rapid surroundings mapping and/or localization of the autonomous mobile device, in particular of the device frame, may advantageously take place. A location and/or a surroundings map may advantageously be at least partially checked for correctness. A surroundings mapping may advantageously take place in an angular range, it being possible for a rotational angle of the device frame to be smaller than the angular range.

In addition, in accordance with an example embodiment of the present invention, it is provided that in a further method step, in particular the above-mentioned further method step, a map of the surroundings of the autonomous mobile device is computed, with the aid of the control or regulation unit, in an angular range of 360° around the autonomous mobile device, based on the data that are measured with the aid of the circular synthetic aperture, the at least one synthetic aperture radar sensor together with the device frame being rotated by an angle of less than 360°, in particular 180° maximum. In particular, in the further method step, a map of the surroundings of the autonomous mobile device is computed, with the aid of the control or regulation unit, in an angular range of 360° around the autonomous mobile device, based on the data that are measured with the aid of the circular synthetic aperture, the detection unit including at least two synthetic aperture radar sensors, in particular the above-mentioned two synthetic aperture radar sensors. In the further method step, a map of the surroundings of the autonomous mobile device is preferably computed, with the aid of the control or regulation unit, in an angular range of 360° around the autonomous mobile device, based on the data that are measured with the aid of the circular synthetic aperture, the at least two synthetic aperture radar sensors being rotated about a total angle of 360°. In the further method step, a map of the surroundings of the autonomous mobile device is particularly preferably computed, with the aid of the control or regulation unit, in an angular range of 360° around the autonomous mobile device, based on the data that are measured with the aid of the circular synthetic aperture, the at least two synthetic aperture radar sensors being situated axially symmetrically with respect to the vertical axis. In the further method step, a map of the surroundings of the autonomous mobile device is particularly preferably computed, with the aid of the control or regulation unit, in an angular range of 360° around the autonomous mobile device, based on the data that are measured with the aid of the circular synthetic aperture, the main directions of irradiation of the at least two synthetic aperture radar sensors pointing in opposite directions. In the further method step, a map of the surroundings of the autonomous mobile device is particularly preferably computed, with the aid of the control or regulation unit, in an angular range of 360° around the autonomous mobile device, based on the data that are measured with the aid of the circular synthetic aperture, the at least two synthetic aperture radar sensors detecting angular ranges that are different from one another. A surroundings mapping may advantageously take place particularly quickly. A rotational angle of a rotation of the device frame for forming a circular synthetic aperture for a surroundings mapping around 360° may be advantageously kept particularly small. A particularly small collision risk may be advantageously achieved upon the formation of a circular synthetic aperture.

Furthermore, in accordance with an example embodiment of the present invention, it is provided that in a further method step, a position, in particular a rotational position, of the at least one synthetic aperture radar sensor is computed, with the aid of the control or regulation unit, based on the data that are measured with the aid of the circular synthetic aperture. In particular, in the further method step a rotational rate and/or a position, in particular a rotational position, of the autonomous mobile device, in particular of the device frame, are/is ascertained by repeatedly detecting the same object in the surroundings of the autonomous mobile device with the aid of the control or regulation unit. The repeated detection preferably takes place using an individual synthetic aperture radar sensor during a rotation of the synthetic aperture radar sensor about the vertical axis, generated by the self-rotation of the device frame about the vertical axis, about a rotational angle of at least 360°. It is also possible for the repeated detection of the same object in the surroundings of the autonomous mobile device to take place using different synthetic aperture radar sensors of the at least two synthetic aperture radar sensors, at least one arrangement of the at least two synthetic aperture radar sensors relative to one another preferably being stored in the control or regulation unit. It is possible for the position, in particular the rotational position, of the at least one synthetic aperture radar sensor to be ascertained in the further method step, based on a SLAM method. A surroundings map and/or a location of the autonomous mobile device, in particular of the device frame, are/is preferably created/ascertained in the further method step as a function of ascertained positions, in particular rotational positions, of the synthetic aperture radar sensor. Alternatively or additionally, it is also possible for a position, in particular a rotational position, of the at least one synthetic aperture radar sensor to be ascertained with the aid of an acceleration sensor system, a rotation rate sensor system, or the like. A position, in particular a rotational position, of a synthetic aperture radar sensor may advantageously be detected cost-effectively and with a simple design.

Moreover, in accordance with an example embodiment of the present invention, it is provided that in a method step, in particular the above-mentioned method step, a spiral-shaped synthetic aperture is generated during a translatory and rotatory movement of the autonomous mobile device. The detection unit, in particular the at least one synthetic aperture radar sensor, preferably has at least three different operating modes.

A first operating mode of the at least three operating modes of the detection unit is preferably a circular operating mode. In the circular operating mode, the control or regulation unit is configured in particular to activate the drive unit in such a way that a self-rotation of the device frame about the vertical axis of the device frame to form a circular synthetic aperture takes place with the aid of the synthetic aperture radar sensor. A second operating mode of the at least three operating modes of the detection unit is preferably a translatory operating mode. In the translatory operating mode, the control or regulation unit is configured in particular to activate the drive unit in such a way that a translatory movement of the device frame to form a translatory synthetic aperture takes place with the aid of the synthetic aperture radar sensor. A third operating mode of the at least three operating modes is preferably a hybrid operating mode, in which the control or regulation unit is configured to activate the drive unit in such a way that a translatory and rotatory movement of the autonomous mobile device, in particular of the device frame, to form a spiral-shaped synthetic aperture takes place. In each of the at least three operating modes, the control or regulation unit is particularly preferably configured to create a surroundings map and/or ascertain a location of the autonomous mobile device, in particular as a function of data that are ascertained with the aid of the particular synthetic aperture. In particular, a map of the surroundings of the autonomous mobile device, in particular the device frame, is created and/or a location of the autonomous mobile device, in particular of the device frame, is ascertained in the method step, based on the data that are detected with the aid of the spiral-shaped synthetic aperture.

Low-collision propulsion of the autonomous mobile device may be advantageously achieved in a particularly flexible manner. A surroundings map and/or a location of the autonomous mobile device may be advantageously updated and/or checked in a particularly simple, rapid, and convenient manner.

The autonomous mobile device according to the present invention and/or the method according to the present invention are/is not intended to be limited to the application and specific embodiment described above. In particular, for fulfilling a mode of operation described herein, the autonomous mobile device according to the present invention and/or the method according to the present invention may include a number of individual elements, components, and units as well as method steps that differ from the number stated herein. In addition, for the value ranges given in the present disclosure, values within the stated limits are also considered to be disclosed and usable as desired.

### BRIEF DESCRIPTION OF THE DRAWINGS

Further advantages result from the following description of the figures. Two exemplary embodiments of the present invention are illustrated in the figures. The figures and the description contain numerous features in combination. Those skilled in the art will also advantageously consider the features individually and combine them into further meaningful combinations, in view of the disclosure herein.

FIG. 1 shows an autonomous mobile device according to an example embodiment of the present invention in a work environment in a schematic top view.

FIG. 2 shows the autonomous mobile device according to an example embodiment of the present invention in a schematic side view.

FIG. 3 shows a schematic sequence of a method according to an example embodiment of the present invention for operating the autonomous mobile device.

FIG. 4 shows a schematic illustration of operating modes of a detection unit of the autonomous mobile device.

FIG. 5 shows an autonomous mobile device according to the present invention in an alternative design, in a schematic side view.

### DETAILED DESCRIPTION OF EXAMPLE EMBODIMENTS

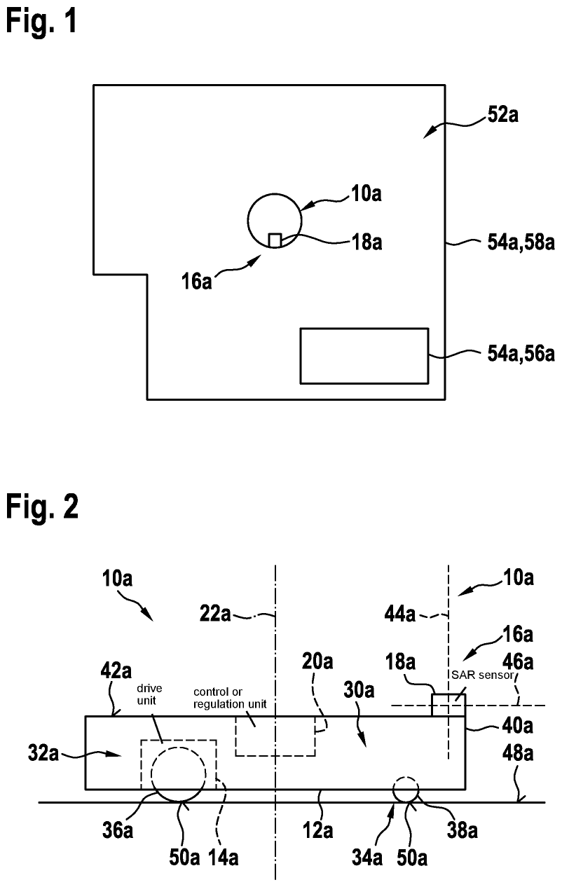

FIG. 1 shows an autonomous mobile device 10a, designed as an autonomous work device, in a schematic top view in a work area 52a. Autonomous mobile device 10a is designed as an autonomous vacuum robot. Alternatively, it is possible for autonomous mobile device 10a to be designed as an autonomous lawn mower robot, as a drone, as an autonomous transport vehicle, in particular as an automated guided vehicle (AGV), as a drivable autonomous industrial robot, as an autonomous service robot, or the like. Autonomous mobile device 10a is configured to move independently. The autonomous mobile device is in particular provided to suction a base surface 48a in work area 52a. Work area 52a is delimited at least by objects 54a. Objects 54a are designed, for example, as a wall 58a, as a cabinet 56a, or the like.

FIG. 2 shows autonomous mobile device 10a, designed as an autonomous work device, in a schematic side view. Autonomous mobile device 10a includes at least one drive unit 14a for generating a propulsion force. Drive unit 14a includes at least one electric motor, for example. Autonomous mobile device 10a has a different design from an autonomous device, in particular an industrial robot, that is permanently installed at a position. Autonomous mobile device 10a includes at least one detection unit 16a, situated at a device frame 12a, for detecting the surroundings of device frame 12a. Detection unit 16a includes at least one synthetic aperture radar (SAR) sensor 18a. Autonomous mobile device 10a includes at least one control or regulation unit 20a for controlling or regulating drive unit 14a and/or detection unit 16a. Control or regulation unit 20a is configured to activate drive unit 14a in such a way that a self-rotation of device frame 12a about a vertical axis 22a of device frame 12a to form a circular synthetic aperture takes place with the aid of synthetic aperture radar sensor 18a. Vertical axis 22a extends at least essentially perpendicularly with respect to a base contact surface 50a of a chassis 30a of autonomous mobile device 10a. Vertical axis 22a extends at least essentially perpendicularly with respect to base surface 48a on which autonomous mobile device 10a moves. Vertical axis 22a extends through a midpoint of device frame 12a, at least viewed in a main plane of extension of device frame 12a. Vertical axis 22a extends at least essentially perpendicularly with respect to the main plane of extension of device frame 12a. Alternatively, it is also possible for vertical axis 22a to extend offset relative to a midpoint of device frame 12a, at least viewed in the main plane of extension of device frame 12a. Vertical axis 22a of device frame 12a intersects device frame 12a. Alternatively, it is also possible for vertical axis 22a to be free of an intersection point with device frame 12a. Control or regulation unit 20a is configured to at least partially create a surroundings map and/or to ascertain a location of device frame 12a as a function of data that are detected with the aid of the circular synthetic aperture. Objects 54a in a detection range of the circular synthetic aperture are detectable with the aid of the circular synthetic aperture.

Autonomous mobile device 10a includes at least chassis 30a, which is situated at device frame 12a. It is possible for chassis 30a to be at least partially formed by device frame 12a. Chassis 30a includes at least one wheel unit 32a and one roller unit 34a for moving autonomous mobile device 10a on a base surface 48a. Base contact surface 50a is formed by a support surface of wheel unit 32a and of roller unit 34a.

Wheel unit 32a includes two wheels 36a designed as rear wheels. However, it is also possible for wheel unit 32a to include one wheel 36a or more than two wheels 36a. For example, it is alternatively possible for wheel unit 32a to include at least two wheels 36a designed as rear wheels, and one or two wheels 36a designed as front wheels. It is possible for all wheels 36a or at least one wheel 36a of wheel unit 32a to be drivable by drive unit 14a. The two wheels 36a are drivable by drive unit 14a. The two wheels 36a are drivable independently of one another by drive unit 14a. Alternatively, it is also possible for a drive of wheels 36a to be at least partially coupled to wheel unit 32a. Wheels 36a of wheel unit 32a are situated at a fixed axle. Alternatively, it is possible for at least one wheel 36a of wheel unit 32a to be steerably situated. Wheels 36a are designed, for example, as rubber wheels or the like. It is also possible for at least one of wheels 36a to be designed as a Mecanum wheel. Roller unit 34a includes a roller 38a that is designed as a guide roller. It is also possible for roller unit 34a to include two or more than two rollers 38a, which in each case may be designed as a guide roller or as a fixed-axis roller. It is possible for roller 38a to be drivable by drive unit 14a. Alternatively or additionally, it is possible for chassis 30a to include at least one chain unit. The chain unit includes in particular at least one crawler track, preferably at least two crawler tracks. In a further possible design of autonomous mobile device 10a, in particular of chassis 30a, that includes two crawler tracks, the two crawler tracks are preferably arranged symmetrically about the midpoint of device frame 12a, at least viewed in the main plane of extension of device frame 12a. In addition, it is possible for the chain unit to include more than two crawler tracks that are preferably arranged symmetrically with respect to the midpoint of device frame 12a or that have some other arbitrary arrangement relative to the midpoint of device frame 12a, in particular at least viewed in the main plane of extension of device frame 12a. The chain unit is in particular drivable with the aid of drive unit 14a. Alternatively, other configurations of chassis 30a that appear meaningful to those skilled in the art are also possible. In particular, in at least one possible exemplary embodiment of autonomous mobile device 10a designed as a drone, autonomous mobile device 10a includes at least one propeller unit, one turbine unit, or the like for propulsion. The propeller unit is preferably drivable with the aid of drive unit 14a. The propeller unit includes, for example, at least one propeller, preferably at least two propellers, and particularly preferably at least four propellers. The turbine unit includes, for example, at least one turbine, preferably multiple turbines.

Drive unit 14a is configured to drive chassis 30a, in particular wheel unit 32a. A movement of device frame 12a is coupled to a drive, in particular to a movement, of the chassis, in particular of wheel unit 32a. A movement of device frame 12a is generatable by chassis 30a, in particular wheel unit 32a, which is driven with the aid of drive unit 14a. The movement of device frame 12a is a function of an activation by control or regulation unit 20a. Drive unit 14a is provided to drive chassis 30a into a translatory and/or rotatory movement of device frame 12a, in particular as a function of an activation by control or regulation unit 20a. Control or regulation unit 20a is configured to activate drive unit 14a at least during a propulsion, in particular a translatory movement, as a function of a surroundings map and/or location of autonomous mobile device 10a, in particular of device frame 12a, that are/is created/ascertained based on data that are measured with the aid of the circular synthetic aperture. A movement of synthetic aperture radar sensor 18a is generatable via a self-rotation of device frame 12a in order to form a circular synthetic aperture with the aid of synthetic aperture radar sensor 18a. A movement of synthetic aperture radar sensor 18a is coupled to a movement of device frame 12a. A movement of synthetic aperture radar sensor 18a is synchronous with a movement of device frame 12a. A transmission ratio of a movement of device frame 12a into a movement of synthetic aperture radar sensor 18a is 1:1. An angular range that is detectable by the circular synthetic aperture is rotated about device frame 12a about vertical axis 22a as a function of a rotational angle. An angular range that is detectable with the aid of the circular synthetic aperture, which is formable in particular with the aid of synthetic aperture radar sensor 18a via a self-rotation of device frame 12a about vertical axis 22a, corresponds to a rotational angle of the self-rotation of device frame 12a about vertical axis 22a. Control or regulation unit 20a is configured to activate drive unit 14a in such a way that a self-rotation of device frame 12a about vertical axis 22a to form a circular synthetic aperture takes place with the aid of synthetic aperture radar sensor 18a, which detects the surroundings of device frame 12a in an angular range of 360°, at least viewed in the main plane of extension of device frame 12a. Control or regulation unit 20a is configured to generate a self-rotation of device frame 12a about vertical axis 22a about a rotational angle of 360° in order to form a circular synthetic aperture with the aid of synthetic aperture radar sensor 18a, which detects the surroundings of device frame 12a in an angular range of 360°, at least viewed in the main plane of extension of device frame 12a. It is also possible for control or regulation unit 20a to be configured to activate drive unit 14a in such a way that a self-rotation of device frame 12a about vertical axis 22a to form a circular synthetic aperture takes place with the aid of synthetic aperture radar sensor 18a, which detects the surroundings of device frame 12a in an angular range of less than 360°, in particular less than 180°. It is possible for an angular range that is to be detected by the circular synthetic aperture to be adjustable.

Control or regulation unit 20a is configured to evaluate the data, measured with the aid of the circular synthetic aperture, based on a simultaneous localization and mapping (SLAM) method.

The simultaneous localization and mapping (SLAM) method is a method for simultaneous position determination and map creation in robotics, in the method, a virtual map of the surroundings of autonomous mobile device 10a, in particular device frame 12a, and a spatial position of autonomous mobile device 10a, in particular device frame 12a, within the virtual map being ascertained, preferably at the same time. A plurality of virtual points from the surroundings of detection unit 16a is preferably detected in the simultaneous localization and mapping (SLAM) method. The virtual points are preferably detectable with the aid of detection unit 16a, in particular the circular synthetic aperture, in particular in an angular range that is detected by the circular synthetic aperture, via features that are depicted on a detected image plane. The individual features are ascertainable, for example, via a phase position evaluation, an intensity evaluation, a polarization evaluation, or the like from radar echoes that are received with the aid of synthetic aperture radar sensor 18a that forms the circular synthetic aperture. The features include in particular multiple virtual points that preferably form a cluster and that are preferably in a certain geometric relationship with one another. The virtual points are preferably ascertainable in each case with the aid of control or regulation unit 20a via the SLAM method as a function of positions of a depiction of a feature that is ascertained in each case from at least two detected images. In particular, exactly one feature is associated with each virtual point. Based on the virtual points, with the aid of control or regulation unit 20a a surroundings map is creatable and at the same time a location of autonomous mobile device 10a, in particular of device frame 12a, is ascertainable, in particular based on the SLAM method. Control or regulation unit 20a is configured to evaluate the data, measured with the aid of the circular synthetic aperture, based on the SLAM method, free of a translatory movement of device frame 12a for simultaneous mapping and localization of autonomous mobile device 10a, in particular device frame 12a. Control or regulation unit 20a is configured to activate drive unit 14a to drive chassis 30a, in particular wheel unit 32a, in such a way that a self-rotation of housing (device) frame 12a, and thus in particular a movement of synthetic aperture radar sensor 18a for forming a circular synthetic aperture, take place due to driven chassis 30a, in particular wheel unit 32a, so that the data required for the SLAM method are detectable by the circular synthetic aperture.

Control or regulation unit 20a is configured to activate drive unit 14a to propel device frame 12a at least as a function of data that are measured with the aid of the circular synthetic aperture, in particular for a collision-free operation. Control or regulation unit 20a is configured to activate drive unit 14a to propel device frame 12a at least as a function of a map of the surroundings of the device frame and/or as a function of the location of device frame 12a, which in particular are/is ascertained based on data that are measured with the aid of the circular synthetic aperture, preferably for a collision-free operation. Control or regulation unit 20a is preferably configured to ascertain, in particular during an initial start-up in an initial step, an initial map of the surroundings of device frame 12a and/or an initial location of device frame 12a, based on data that are measured with the aid of the circular synthetic aperture, in particular for a collision-free operation. Control or regulation unit 20a is configured to ascertain a map of the surroundings of device frame 12a and/or a location of device frame 12a, free of and/or prior to a translatory movement of device frame 12a, preferably in an initial step during an initial start-up, at least as a function of data that are detected with the aid of the circular synthetic aperture. It is possible for control or regulation unit 20a to be configured to activate drive unit 14a to propel device frame 12a at least as a function of a dimension of device frame 12a, in particular as a function of a maximum spatial extent of device frame 12a, in particular for a collision-free operation. It is also possible for control or regulation unit 20a to be configured to activate drive unit 14a to propel the device frame at least as a function of components/accessories situated at device frame 12a, in particular as a function of a spatial extent of components/accessories situated at device frame 12a, in particular for a collision-free operation. Control or regulation unit 20a is preferably configured to activate drive unit 14a to drive chassis 30a in order to generate at least one translatory initial movement of device frame 12a as a function of the initial map of the surroundings of device frame 12a, of the initial location of device frame 12a, of a spatial extent of device frame 12a, and/or as a function of components/accessories situated at device frame 12a, in particular as a function of their spatial extent. In addition, it is possible for a translatory movement of device frame 12a to be blockable as a function of the presence of an initial map of the surroundings of device frame 12a and/or of a location of device frame 12a.

Synthetic aperture radar sensor 18a is rotatably fixedly, in particular rigidly, connected to device frame 12a for generating a circular synthetic aperture. Synthetic aperture radar sensor 18a is situated at a housing 40a of autonomous mobile device 10a, at least a portion of housing 40a to which synthetic aperture radar sensor 18a is fastened being rigidly, in particular rotatably fixedly, connected to device frame 12a. Synthetic aperture radar sensor 18a is rotatably fixedly situated at housing 40a, free of a possibility of relative movement, in particular free of a movable bearing by a bearing unit designed as a roller bearing, as a slide bearing, or the like, relative to device frame 12a and/or housing 40a. Synthetic aperture radar sensor 18a is situated on an outer surface 42a of housing 40a. It is alternatively possible for synthetic aperture radar sensor 18a to be situated in housing 40a. Synthetic aperture radar sensor 18a is situated on a side of autonomous mobile device 10a, in particular of housing 40a, that faces away from another side of autonomous mobile device 10a, in particular of housing 40a, at which chassis 30a, in particular wheel unit 32a and roller unit 34a, is/are situated.

Alternatively, it is also possible for synthetic aperture radar sensor 18a to be situated directly at device frame 12a, in particular fastened thereto. Control or regulation unit 20a is at least essentially completely situated in housing 40a. Drive unit 14a is at least partially situated within housing 40a. Device frame 12a is provided to support housing 40a, and/or at least partially forms housing 40a. Alternatively, it is also possible for housing 40a to be situated at device frame 12a so that it is at least partially movably supported relative to device frame 12a, synthetic aperture radar sensor 18a being rigidly, in particular rotatably fixedly, connected to device frame 12a, for example situated directly at device frame 12a, in particular fastened thereto. It is also possible for synthetic aperture radar sensor 18a to be designed, at least in part, as one piece with device frame 12a and/or housing 40a.

Synthetic aperture radar sensor 18a, viewed in a plane extending perpendicularly with respect to vertical axis 22a of device frame 12a, is situated offset relative to vertical axis 22a. The plane extending perpendicularly with respect to vertical axis 22a of device frame 12a extends at least essentially in parallel to the main plane of extension of device frame 12a. It is also possible for the plane extending perpendicularly with respect to vertical axis 22a of device frame 12a to correspond to the main plane of extension of device frame 12a. A movement of synthetic aperture radar sensor 18a on a circular path about vertical axis 22a is generatable by a self-rotation of device frame 12a about vertical axis 22a. The circular path extends at least essentially in parallel to the main plane of extension of device frame 12a. Synthetic aperture radar sensor 18a includes at least one main point of action that corresponds to a main point of emission and/or a main point of reception of synthetic aperture radar sensor 18a. A maximum transmission power and/or a maximum reception power of synthetic aperture radar sensor 18a are/is achievable at the main point of action. The main point of emission is in particular a point of the antenna directional characteristic of synthetic aperture radar sensor 18a at which a maximum transmission power of synthetic aperture radar sensor 18a is achievable. The main point of reception is in particular a point of the antenna directional characteristic of synthetic aperture radar sensor 18a at which a maximum reception power of synthetic aperture radar sensor 18a is achievable. Synthetic aperture radar sensor 18a has at least one center axis 44a that extends at least essentially in parallel to vertical axis 22a. Center axis 44a of synthetic aperture radar sensor 18a intersects at least the main point of action of synthetic aperture radar sensor 18a. Center axis 44a of synthetic aperture radar sensor 18a extends at a distance from vertical axis 22a. The main point of action of synthetic aperture radar sensor 18a is situated at a distance from vertical axis 22a of device frame 12a. A movement of synthetic aperture radar sensor 18a is a function of a movement of device frame 12a. Synthetic aperture radar sensor 18a has a main effective axis 46a along which a maximum transmission power and/or maximum reception power of synthetic aperture radar sensor 18a are/is achievable. Main effective axis 46a of synthetic aperture radar sensor 18a extends at least essentially perpendicularly with respect to vertical axis 22a of device frame 12a and/or to center axis 44a of synthetic aperture radar sensor 18a. Main effective axis 46a and center axis 44a preferably intersect at a point that corresponds to the main point of action of synthetic aperture radar sensor 18a. A main direction of irradiation along which synthetic aperture radar sensor 18a has a maximum radiation power extends in parallel to main effective axis 46a of synthetic aperture radar sensor 18a. The main direction of irradiation of synthetic aperture radar sensor 18a extends radially outwardly, at least viewed starting from vertical axis 22a of device frame 12a. A main direction of reception along which synthetic aperture radar sensor 18a has a maximum reception power extends in parallel to main effective axis 46a of synthetic aperture radar sensor 18a, in particular in a direction opposite the main direction of irradiation.

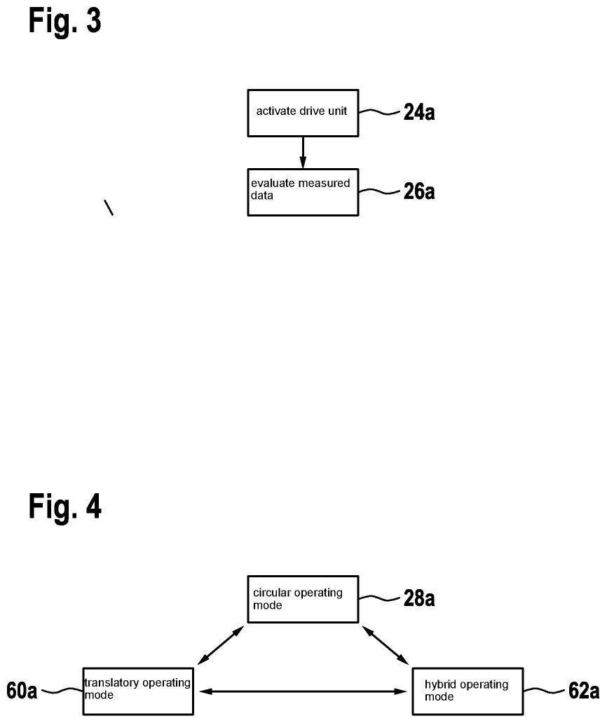

FIG. 3 shows a schematic sequence of a method for operating autonomous mobile device 10a. Drive unit 14a of autonomous mobile device 10a is activated by control or regulation unit 20a to generate a self-rotation of device frame 12a of autonomous mobile device 10a about vertical axis 22a in at least one method step 24a, so that a circular synthetic aperture for a localization of autonomous mobile device 10a and/or for mapping the surroundings of autonomous mobile device 10a is formed by synthetic aperture radar sensor 18a.

Synthetic aperture radar sensor 18a is preferably moved synchronously with device frame 12a in method step 24a. Device frame 12a is rotated relative to a base surface 48a and/or the surroundings with the aid of drive unit 14a in method step 24a. Synthetic aperture radar sensor 18a is moved on a circular path about vertical axis 22a by a self-rotation of device frame 12a about vertical axis 22a. Method step 24a is preferably carried out prior to a translatory movement of autonomous mobile device 10a, in particular of device frame 12a. Method step 24a is in particular an initial step during an initial start-up of autonomous mobile device 10a. Device frame 12a is rotated about a rotational angle of 360° about vertical axis 22a with the aid of drive unit 14a in method step 24a. However, it is also possible for device frame 12a to be rotated in method step 24a about a rotational angle of less than 360°, preferably less than 180°, or greater than 360°, in particular as a function of an angular range around autonomous mobile device 10a, in particular device frame 12a, to be monitored. Objects in a detection range of the circular synthetic aperture are detected with the aid of the circular synthetic aperture in method step 24a.

Autonomous mobile device 10a, in particular detection unit 16a, preferably the at least one synthetic aperture radar sensor 18a, has at least three different operating modes (cf. FIG. 4). A first operating mode of the at least three operating modes is a circular operating mode 28a. In the circular operating mode, control or regulation unit 20a is configured to activate drive unit 14a in such a way that a self-rotation of device frame 12a about vertical axis 22a of device frame 12a to form a circular synthetic aperture takes place with the aid of synthetic aperture radar sensor 18a, the circular operating mode corresponding in particular to the description for method step 24a. A second operating mode of the at least three operating modes is a translatory operating mode 60a. In the translatory operating mode 60a, control or regulation unit 20a is configured to activate drive unit 14a in such a way that a translatory movement of device frame 12a to form a translatory synthetic aperture takes place with the aid of synthetic aperture radar sensor 18a, in particular in method step 24a. A third operating mode of the at least three operating modes is a hybrid operating mode 62a, in which control or regulation unit 20a is configured to activate drive unit 14a in such a way that a translatory and rotatory movement of autonomous mobile device 10a, in particular of device frame 12a, to form a spiral-shaped synthetic aperture takes place with the aid of synthetic aperture radar sensor 18a, in particular in method step 24a. Control or regulation unit 20a is configured to create a surroundings map and/or ascertain a location of autonomous mobile device 10a, in particular as a function of data that are ascertained with the aid of the particular synthetic aperture, in each of the at least three operating modes. The operating mode of autonomous mobile device 10a, in particular of detection unit 16a, preferably of the at least one synthetic aperture radar sensor 18a, is switchable, preferably at any time. Control or regulation unit 20a is configured to switch between the different operating modes.

Data that are measured with the aid of the circular synthetic aperture are evaluated based on a SLAM method in at least one further method step 26a. A virtual map of the surroundings of autonomous mobile device 10a and a spatial position of autonomous mobile device 10a within the virtual map are ascertained at the same time in further method step 26a, in particular based on the data that are measured with the aid of the circular synthetic aperture. A plurality of virtual points from the surroundings of detection unit 16a is detected in further method step 26a. The virtual points are detected in further method step 26a via features that are depicted on a detected image plane, with the aid of detection unit 16a, in particular the circular synthetic aperture. The individual features are ascertained in further method step 26a via a phase position evaluation, an intensity evaluation, a polarization evaluation, or the like by radar echoes that are received by synthetic aperture radar sensor 18a. The features include in particular multiple virtual points that form a cluster and that are in a certain geometric relationship with one another. The virtual points are ascertained with the aid of control or regulation unit 20a in further method step 26a, in each case as a function of positions of a depiction of a feature in each case that are ascertained from at least two detected images. In particular, a feature is associated with each virtual point in further method step 26a. Based on the virtual points, a surroundings map is created, and at the same time a location of autonomous mobile device 10a, in particular of device frame 12a, is ascertained, in further method step 26a with the aid of control or regulation unit 20a, in particular based on the SLAM method.

A position, in particular a rotational position, of the at least one synthetic aperture radar sensor 18a is computed, with the aid of control or regulation unit 20a, in further method step 26a based on the data that are measured with the aid of the circular synthetic aperture. A rotational rate and/or a position, in particular a rotational position, of autonomous mobile device 10a, in particular of device frame 12a, and/or of synthetic aperture radar sensor 18a are/is ascertained in further method step 26a by repeatedly detecting the same object in the surroundings of autonomous mobile device 10a with the aid of control or regulation unit 20a. The repeated detection takes place using synthetic aperture radar sensor 18a during a rotation of synthetic aperture radar sensor 18a about vertical axis 22a, generated by the self-rotation of device frame 12a about vertical axis 22a, about a rotational angle of at least 360°. It is possible for the position, in particular the rotational position, of the at least one synthetic aperture radar sensor 18a to be ascertained based on a SLAM method in further method step 26a. A surroundings map and/or a location of autonomous mobile device 10a, in particular of device frame 12a, are/is created/ascertained in further method step 26a as a function of ascertained positions, in particular rotational positions, of synthetic aperture radar sensor 18a. Alternatively or additionally, it is also possible for a position, in particular a rotational position, of the at least one synthetic aperture radar sensor 18a to be ascertained with the aid of an acceleration sensor system, rotation rate sensor system, or the like. Further method step 26a may also be analogously carried out in the translatory operating mode and/or in the hybrid operating mode.

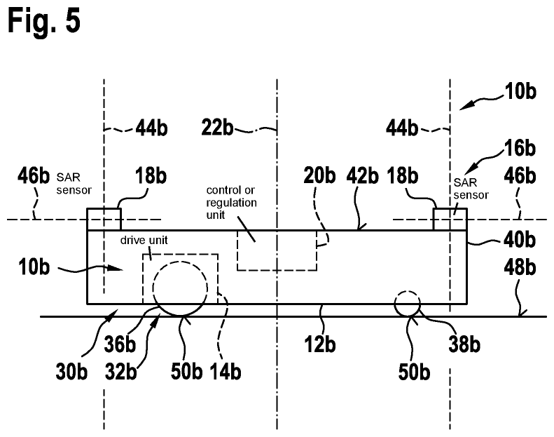

FIG. 5 shows a further exemplary embodiment of the present invention. The following descriptions and the figures are limited essentially to the differences between the exemplary embodiments; with regard to components that are denoted in the same way, in particular with regard to components having the same reference numerals, reference may basically also be made to the figures and/or the description of the other exemplary embodiments, in particular in FIGS. 1 through 4. To distinguish between the exemplary embodiments, the letter “a” is added as a suffix to the reference numerals of the exemplary embodiment in FIGS. 1 through 4. In the exemplary embodiment in FIG. 5, the letter “a” is replaced by the letter “b.”

FIG. 5 shows an autonomous mobile device 10b, designed as an autonomous work device, in a schematic side view. Autonomous mobile device 10b includes at least one drive unit 14b for generating a propulsion force. Autonomous mobile device 10b includes at least one detection unit 16b, situated at a device frame 12b, for detecting the surroundings of device frame 12b. Detection unit 16b includes two synthetic aperture radar (SAR) sensors 18b. Autonomous mobile device 10b includes at least one control or regulation unit 20b for controlling or regulating drive unit 14b and/or detection unit 16b. Control or regulation unit 20b is configured to activate drive unit 14b in such a way that a self-rotation of device frame 12b about a vertical axis 22b of device frame 12b to form a circular synthetic aperture takes place with the aid of the two synthetic aperture radar sensors 18b. The two synthetic aperture radar sensors 18b together form a combined circular synthetic aperture that is generated by a self-rotation of device frame 12b about vertical axis 22b of device frame 12b with the aid of drive unit 14b. Control or regulation unit 20b is configured to activate drive unit 14b in such a way that a self-rotation of device frame 12b about vertical axis 22b takes place, so that a circular synthetic aperture is formable by each of the at least two synthetic aperture radar sensors 18b. Control or regulation unit 20b is configured to process data, detected with the aid of the particular circular synthetic apertures of the at least two synthetic aperture radar sensors 18b, to ascertain a surroundings map and/or to locate device frame 12b, in particular based on a SLAM method. It is also possible for control or regulation unit 20b to be configured to create in each case a surroundings map as a function of data, measured with the aid of the particular synthetic aperture, of the at least two synthetic aperture radar sensors 18b, and/or to ascertain a location of device frame 12b, in particular based on a SLAM method. Control or regulation unit 20b is preferably configured to compare the surroundings maps, generated with the aid of the particular circular synthetic aperture of the at least two synthetic aperture radar sensors 18b, and/or to combine them to form a combined surroundings map. Control or regulation unit 20b is particularly preferably configured to compare the locations of device frame 12b, ascertained, with the aid of the control or regulation unit 20b, as a function of the data that are detected with the aid of the particular circular synthetic aperture of the at least two synthetic aperture radar sensors 18b. In particular, it is possible for an average value for a location of device frame 12b to be ascertainable by control or regulation unit 20b, based on locations of device frame 12b that are ascertained in particular as a function of the data that are detected with the aid of the particular circular synthetic apertures of the at least two synthetic aperture radar sensors 18b.

The two synthetic aperture radar sensors 18b, viewed in a plane extending perpendicularly with respect to vertical axis 22b of device frame 12b, are situated offset relative to vertical axis 22b. The at least two synthetic aperture radar sensors 18b are situated symmetrically around vertical axis 22b. The at least two synthetic aperture radar sensors 18b are situated axially symmetrically with respect to vertical axis 22b. Alternatively, it is also possible for the at least two synthetic aperture radar sensors 18b to be situated asymmetrically around vertical axis 22b of device frame 12b. The at least two synthetic aperture radar sensors 18b are rigidly, in particular rotatably fixedly, connected to device frame 12b. The at least two synthetic aperture radar sensors 18b are situated at a portion of a housing 40b of autonomous mobile device 10b that is rigidly, in particular rotatably fixedly, connected to device frame 12b. Synthetic aperture radar sensors 18b are situated on an outer surface 42b of housing 40b. Synthetic aperture radar sensors 18b are situated on a side of autonomous mobile device 10b, in particular of housing 40b, that faces away from another side of autonomous mobile device 10b, in particular of housing 40b, at which a chassis 30b of autonomous mobile device 10b, in particular a wheel unit 32b of chassis 30b and a roller unit 34b of chassis 30b, is/are situated. Alternatively, it is possible for the at least two synthetic aperture radar sensors 18b to be situated directly at device frame 12b, in particular fastened thereto. The at least two synthetic aperture radar sensors 18b each have a main point of action that corresponds to a main point of emission and/or a main point of reception of particular synthetic aperture radar sensor 18b. The at least two synthetic aperture radar sensors 18b each have a center axis 44b that extends at least essentially in parallel to vertical axis 22b. Particular center axis 44b of the two synthetic aperture radar sensors 18b intersects at least the main point of action of particular synthetic aperture radar sensor 18b. Center axes 44b of the two synthetic aperture radar sensors 18b extend at least essentially in parallel to one another. Center axes 44b of the at least two synthetic aperture radar sensors 18b are situated at a distance from vertical axis 22b. The two synthetic aperture radar sensors 18b each have a main effective axis 46b, main effective axes 46b extending at least essentially in parallel to one another. A maximum transmission power and/or maximum reception power of particular synthetic aperture radar sensor 18b are/is achievable along the particular main effective axis of the at least two synthetic aperture radar sensors 18b. Alternatively, it is possible for the two synthetic aperture radar sensors 18b to be situated in such a way that their main effective axes 46b extend at an angle to one another. Particular main effective axes 46b of the at least two synthetic aperture radar sensors 18b extend in parallel to a main plane of extension of device frame 12b. It is possible for particular main effective axes 46b of the at least two synthetic aperture radar sensors 18b to extend in the main plane of extension of device frame 12b. Particular main effective axes 46b of the two synthetic aperture radar sensors 18b intersect at at least one point. Particular main effective axes 46b of the two synthetic aperture radar sensors 18b intersect with vertical axis 22b at least at a shared intersection point. Main effective axes 46b of the two synthetic aperture radar sensors 18b correspond to one another. Particular main directions of irradiation of the two synthetic aperture radar sensors 18b point in opposite directions. Alternatively, it is possible for the two synthetic aperture radar sensors 18b to be situated in such a way that their main directions of irradiation extend at an angle to one another.

In a method for operating autonomous mobile device 10b, drive unit 14b of autonomous mobile device 10b is activated by control or regulation unit 20b in at least one method step for generating a self-rotation of device frame 12b of autonomous mobile device 10b about vertical axis 22b, so that a circular synthetic aperture for a localization of autonomous mobile device 10b and/or for a mapping of the surroundings of autonomous mobile device 10b is formed by synthetic aperture radar sensors 18b. In the method step, with the aid of multiple synthetic aperture radar sensors 18b, in particular the two synthetic aperture radar sensors 18b, situated at device frame 12b, a combined circular synthetic aperture is generated by a self-rotation of device frame 12b about vertical axis 22b of device frame 12b that is generated with the aid of drive unit 14b. In the method step, drive unit 14b is activated with the aid of control or regulation unit 20b in such a way that a self-rotation of device frame 12b about vertical axis 22b takes place, so that in each case a circular synthetic aperture is formed by the at least two synthetic aperture radar sensors 18b.

In a further method step, data that are detected with the aid of the particular circular synthetic apertures of the two synthetic aperture radar sensors 18b are processed with the aid of control or regulation unit 20b to create a surroundings map and/or to locate device frame 12b, in particular based on a SLAM method. It is also possible that in the further method step, a surroundings map is created and/or a location of device frame 12b is ascertained, in each case with the aid of control or regulation unit 20b as a function of data that are measured with the aid of the particular synthetic aperture of the two synthetic aperture radar sensors 18b, preferably based on a SLAM method. In the further method step, surroundings maps that are created with the aid of the particular circular synthetic aperture of the two synthetic aperture radar sensors 18b are particularly preferably compared and/or combined with the aid of control or regulation unit 20b to form a combined surroundings map. In the further method step, locations of device frame 12b that are ascertained as a function of the data that are detected with the aid of the particular circular synthetic apertures of the two synthetic aperture radar sensors 18b, are particularly preferably compared with the aid of control or regulation unit 20b. In particular, it is possible for an average value for a location of device frame 12b to be ascertained in the further method step, with the aid of control or regulation unit 20b, from the locations of device frame 12b ascertained in particular as a function of the data that are detected with the aid of the particular circular synthetic aperture of the two synthetic aperture radar sensors 18b.

In the further method step, a map of the surroundings of autonomous mobile device 10b is computed, with the aid of control or regulation unit 20b, in an angular range of 360° around autonomous mobile device 10b, based on the data that are measured with the aid of the circular synthetic aperture, the two synthetic aperture radar sensors 18b together with device frame 12b being rotated by an angle of less than 360°, in particular 180° maximum. In the further method step, a map of the surroundings of autonomous mobile device 10b is computed, with the aid of control or regulation unit 20b, in an angular range of 360° around autonomous mobile device 10b, based on the data that are measured with the aid of the circular synthetic aperture, the at least two synthetic aperture radar sensors 18b being rotated about a total angle of 360°. In the further method step, a map of the surroundings of autonomous mobile device 10b is computed, with the aid of control or regulation unit 20b, in an angular range of 360° around autonomous mobile device 10b from the data that are measured with the aid of the circular synthetic aperture, the at least two synthetic aperture radar sensors 18b detecting different angular ranges.

In the further method step, a position, in particular a rotational position, of the two synthetic aperture radar sensors 18b is computed, with the aid of control or regulation unit 20b, based on the data that are measured with the aid of the circular synthetic aperture. In the further method step, a rotational rate and/or a position, in particular a rotational position, of autonomous mobile device 10b, in particular of device frame 12b, are/is ascertained by repeatedly detecting the same object in the surroundings of autonomous mobile device 10b with the aid of control or regulation unit 20b. The repeated detection of the same object in the surroundings of autonomous mobile device 10b takes place using the two synthetic aperture radar sensors 18b. For example, at least one arrangement of the two synthetic aperture radar sensors 18b relative to one another is stored in control or regulation unit 20b.

1-13. (canceled)

14. An autonomous mobile work device, comprising:
at least one device frame;
at least one drive unit configured to generate a propulsion force;
at least one detection unit, situated in or at the device frame, configured to detect surroundings of the device frame, the detection unit including at least one synthetic aperture radar (SAR) sensor; and
at least one control or regulation unit configured to control or regulate the drive unit and/or the detection unit, the control or regulation unit being configured to activate the drive unit in such a way that a self-rotation of the device frame about a vertical axis of the device frame to form a circular synthetic aperture takes place with the aid of the synthetic aperture radar sensor.

15. The autonomous mobile device as recited in claim 14, wherein the control or regulation unit is configured to evaluate data, measured using the circular synthetic aperture, based on a simultaneous localization and mapping (SLAM) method.

16. The autonomous mobile device as recited in claim 14, wherein the control or regulation unit is configured to activate the drive unit to propel the device frame at least as a function of data measured with the aid of the circular synthetic aperture, for a collision-free operation.

17. The autonomous mobile device as recited in claim 14, wherein the synthetic aperture radar sensor is rotatably fixedly, rigidly, connected to the device frame.

18. The autonomous mobile device as recited in claim 14, wherein the synthetic aperture radar sensor, viewed in a plane extending perpendicularly with respect to the vertical axis of the device frame, is situated offset relative to the vertical axis.

19. The autonomous mobile device as recited in claim 14, wherein the detection unit includes at least two synthetic aperture radar sensors which, viewed in a plane extending perpendicularly with respect to the vertical axis of the device frame, are situated offset relative to the vertical axis.

20. The autonomous mobile device as recited in claim 14, wherein the detection unit includes at least two synthetic aperture radar sensors, which together form the circular synthetic aperture via the self-rotation of the device frame, generated using the drive unit, about the vertical axis of the device frame.

21. A method for operating an autonomous mobile device, including a detection unit configured to detect surroundings of the autonomous mobile device, the detection unit including at least one synthetic aperture radar (SAR) sensor, the method comprising the following steps:
activating a drive unit of the autonomous mobile device by a control or regulation unit, to generate a self-rotation of a device frame of the autonomous mobile device about a vertical axis, so that a circular synthetic aperture for a localization of the autonomous mobile device and/or for a mapping of the surroundings of the autonomous mobile device is formed by the synthetic aperture radar sensor.

22. The method as recited in claim 21, wherein data that are measured with the aid of the circular synthetic aperture are evaluated in a further method step, based on a simultaneous localization and mapping (SLAM) method.

23. The method as recited claim 21, further comprising:
generating, with the aid of multiple synthetic aperture radar sensors situated at the device frame, a combined circular synthetic aperture by the self-rotation of the device frame about the vertical axis of the device frame that is generated with the aid of the drive unit.

24. The method as recited in claim 21, further comprising:
computing a map of the surroundings of the autonomous mobile device, with the aid of the control or regulation unit, in an angular range of 360° around the autonomous mobile device, based on data that are measured with the aid of the circular synthetic aperture, the at least one synthetic aperture radar sensor together with the device frame being rotated by an angle of less than 360°.

25. The method as recited in claim 24, wherein the angle is 180° maximum.

26. The method as recited in claim 21, further comprising:
computing a rotational position of the at least one synthetic aperture radar sensor, with the aid of the control or regulation unit, based on data that are measured with the aid of the circular synthetic aperture.

27. The method as recited in claim 21, further comprising:
generating a spiral-shaped synthetic aperture during a translatory and rotatory movement of the autonomous mobile device.
